(19) United States
(12) Patent Application Publication
(10) Pub. No.: US 2019/0105935 A1
(43) Pub. Date: Apr. 11, 2019

(54) DOUBLE-SIDED VARNISHING APPARATUS

(71) Applicant: KOMORI CORPORATION, Tokyo (JP)

(72) Inventor: Hiroyoshi KAMODA, Ibaraki (JP)

(21) Appl. No.: 16/086,588

(22) PCT Filed: Mar. 15, 2017
(86) PCT No.: PCT/JP2017/010357

§ 371 Date: Sep. 19, 2018

(30) Foreign Application Priority Data
Mar. 22, 2016 (JP) 2016-056663

(51) Int. Cl. B41M 7/02; B41F 23/04; B41F 23/08; B41F 19/02; B41F 11/00

(52) U.S. Cl. CPC B41M 7/02; B41F 23/04; B41F 11/00; B41F 19/02; B41F 23/08

(57) ABSTRACT

A double-sided varnishing apparatus includes a varnishing unit configured to apply varnish to both surfaces of a sheet, and an additional processing unit configured to perform additional processing on the sheet on an upstream side in a sheet conveyance direction with respect to the varnishing unit. The additional processing unit includes a first embossing unit, and a special unit located on the upstream side in the sheet conveyance direction with respect to the first embossing unit. The special unit is one of an offset printing unit, a flexographic printing unit, and a second embossing unit. These units are interchangeable with each other. Value can be added to a polymer-made sheet.

### TECHNICAL FIELD

The present invention relates to a double-sided varnishing apparatus including an additional processing unit that increases added value.

### BACKGROUND ART

Conventionally, a polymer-made paper money is coated on both surfaces in order to improve durability. As a coating apparatus capable of executing this coating, there exists an apparatus disclosed in, for example, patent literature 1. The coating apparatus disclosed in patent literature 1 includes an obverse surface-side coating unit that coats the obverse surface of a sheet and a reverse surface-side coating unit that coats the reverse surface of the sheet. These coating units include anilox rollers, chamber devices, and the like, respectively, and are arrayed side by side in a sheet conveyance direction.

Some coating apparatuses can provide a sheet with a convex portion different in touch when the user touches it, as disclosed in, for example, patent literature 2. The coating apparatus disclosed in patent literature 2 adopts an arrangement of forming a partially thick convex portion on a sheet by screen printing. Value can be added to a sheet using the coating apparatus disclosed in patent literature 2. As a printing method capable of providing a convex portion on a sheet, intaglio printing is known in addition to screen printing.

### RELATED ART LITERATURE

### Patent Literature

Patent Literature 1: Japanese Patent Laid-Open No. 2000-103035

Patent Literature 2: Japanese Patent Laid-Open No. 2014-148045

### DISCLOSURE OF INVENTION

### Problem to be Solved by the Invention

It is desired to add value to a polymer-made sheet, especially a paper money, by performing additional printing on a printed polymer-made sheet or providing a convex portion different in touch for the purpose of value addition including the anti-forgery technique, consideration for the user, and improvement of the sense of use. The additional printing is desirably executed while changing the printing method according to a sheet, so as not to impair an image already printed on the sheet. Such additional printing is impossible in the coating apparatus disclosed in patent literature 1.

To provide a convex portion different in touch on a polymer-made sheet, the coating apparatus disclosed in patent literature 2 may be used. However, it is difficult to thickly apply a coating liquid such as varnish or ink to a polymer-made sheet. It is therefore hard for the coating apparatus disclosed in patent literature 2 and a related intaglio printing press to form a convex portion different in touch.

The present invention has been made to solve the above-described problems, and has as its object to provide a double-sided varnishing apparatus capable of adding value to a polymer-made sheet.

### Means of Solution to the Problem

In order to achieve the above object of the present invention, there is provided a double-sided varnishing apparatus including

a varnishing unit including a first varnishing unit configured to apply varnish to one surface of a sheet, and a second varnishing unit arranged on a downstream side in a sheet conveyance direction with respect to the first varnishing unit and configured to apply varnish to the other surface of the sheet, and

an additional processing unit provided on an upstream side in the sheet conveyance direction with respect to the varnishing unit and configured to perform additional processing on the sheet,

wherein the additional processing unit includes

a first embossing unit configured to perform embossing on the sheet, and

a special unit provided on the upstream side in the sheet conveyance direction with respect to the first embossing unit and configured to perform additional processing on the sheet,

the special unit is one of

an offset printing unit configured to perform offset printing on the sheet,

a flexographic printing unit configured to perform flexographic printing on the sheet, and

a second embossing unit configured to perform embossing on the sheet, and

the offset printing unit, the flexographic printing unit, and the second embossing unit are configured to be interchangeable with each other.

### Effect of the Invention

According to the present invention, embossing, and processing by the special unit are performed on a sheet on the upstream side in the sheet conveyance direction with respect to the varnishing unit. The additional processing unit adds value to the sheet in addition to varnishing of both surfaces. The special unit performs one of offset printing, flexographic printing, and embossing, and the degree of freedom is high in value addition. According to the present invention, it is possible to provide a double-sided varnishing apparatus capable of obtaining a high value-added sheet.

### BRIEF DESCRIPTION OF DRAWINGS

FIG. 1 is side view showing the arrangement of a double-sided varnishing apparatus according to an embodiment of the present invention;

FIG. 2 is a side view showing a part of a skeleton cylinder and a third impression cylinder;

FIG. 3 is a side view showing the arrangement of an offset printing unit;

FIG. 4 is a side view showing the arrangement of a flexographic printing unit;

FIG. 5 is a side view showing the arrangement of an embossing unit serving as a special unit;

FIG. 6 is a side view showing a part of the embossing unit and a second impression cylinder; and

FIG. 7 is a block diagram showing the arrangement of a control system.

### BEST MODE FOR CARRYING OUT THE INVENTION

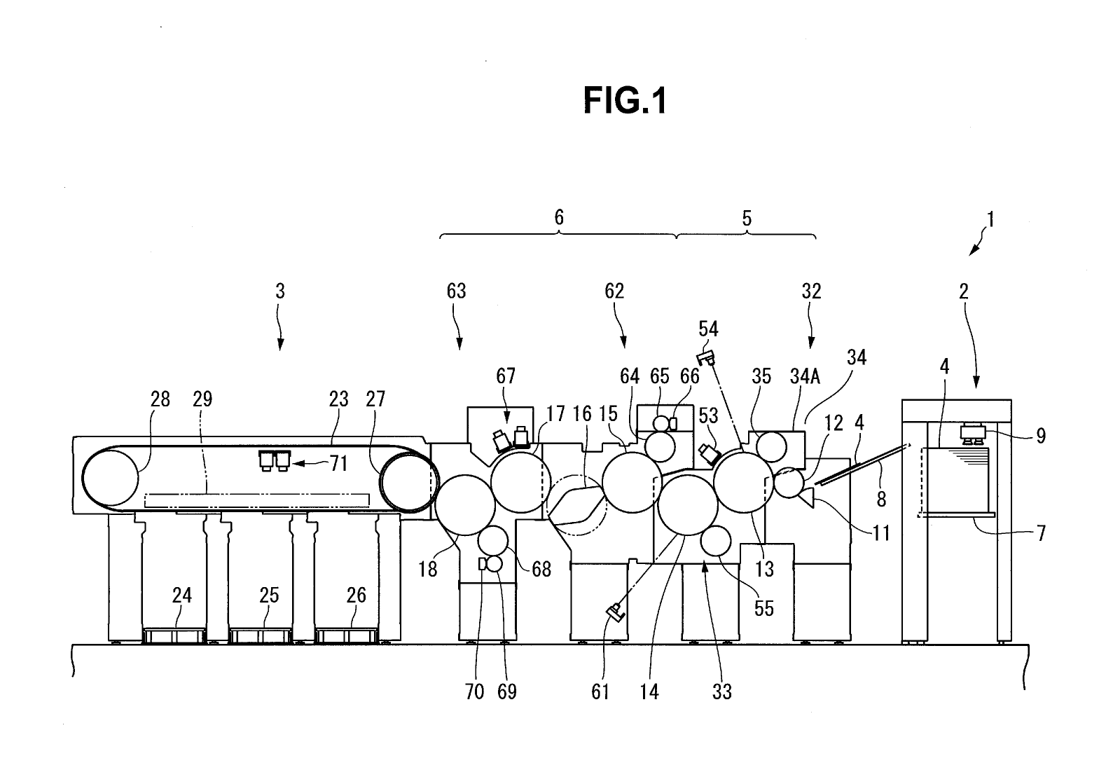

An embodiment of a double-sided varnishing apparatus according to the present invention will be described in detail below with reference to FIGS. 1 to 7. A double-sided varnishing apparatus 1 shown in FIG. 1 is an apparatus that feeds a sheet 4 from a feeder unit 2 located on the rightmost side in FIG. 1 to a delivery unit 3 located on the leftmost side and performs a plurality of processes on the sheet 4 in the middle of conveyance. The sheet 4 fed from the feeder unit 2 is a polymer-made sheet serving as, for example, a paper money. An image including a pattern, a character, and a number is printed in advance on both the obverse and reverse surfaces of the sheet 4. In this embodiment, the feeder unit 2 corresponds to “sheet supply device”.

The plurality of processes to be performed on the sheet 4 are additional processing to be executed in an additional processing unit 5 adjacent to the feeder unit 2 and varnishing to be executed in a varnishing unit 6 located between the additional processing unit 5 and the delivery unit 3, details of which will be described later. The varnishing mentioned here is coating processing of coating the sheet 4 with varnish.

The feeder unit 2 of the double-sided varnishing apparatus 1 includes a feeder pile 7 on which a number of sheets 4 are stacked, a sucker 9 that feeds out the sheets 4 located uppermost one by one onto a feeder board 8, and the like. The feeder board 8 feeds the sheet 4 from the feeder unit 2 to the additional processing unit 5 side. The sheet 4 fed by the feeder board 8 is fed to a first transfer cylinder 12 by a swing device 11. The first transfer cylinder 12 contacts a first impression cylinder 13 of the additional processing unit 5. Accordingly, the sheet 4 is fed to the first impression cylinder 13 via the first transfer cylinder 12.

The first impression cylinder 13 contacts a second impression cylinder 14. The second impression cylinder 14 contacts a third impression cylinder 15. The third impression cylinder 15 contacts a skeleton cylinder 16. The skeleton cylinder 16 contacts a drying cylinder 17. The drying cylinder 17 contacts a fourth impression cylinder 18. The fourth impression cylinder 18 feeds the sheet 4 to the delivery unit 3 to be described later. Accordingly, the sheet 4 is conveyed from the first impression cylinder 13 to the delivery unit 3 via the second impression cylinder 14 of the additional processing unit 5, the third impression cylinder 15, skeleton cylinder 16, drying cylinder 17, and fourth impression cylinder 18 of the varnishing unit 6, and the like.

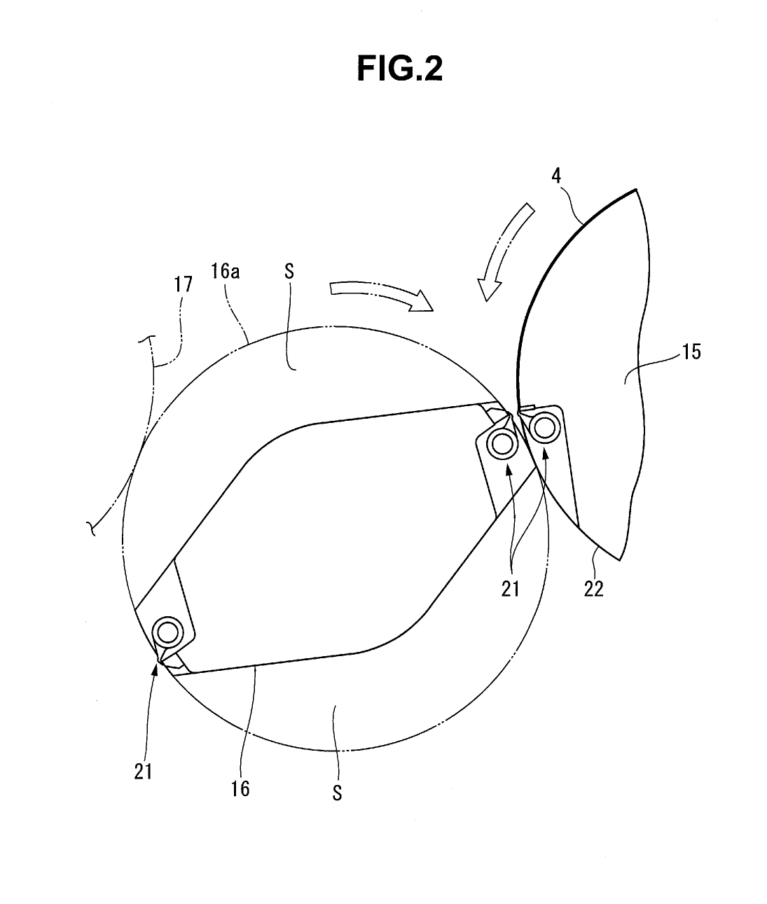

These cylinders having a function of conveying the sheet 4 include gripper devices 21 each of which selectively grips a gripping-side end portion (an end portion on the downstream side in the conveyance direction) serving as the leading edge of the sheet 4, as shown in FIG. 2. Of these cylinders, all the other cylinders (the first transfer cylinder 12, the first impression cylinder 13, the second impression cylinder 14, the third impression cylinder 15, the drying cylinder 17, and the fourth impression cylinder 18) except the skeleton cylinder 16 have effective surfaces 22 on each of which the sheet 4 is laid and supported. The first transfer cylinder 12 includes a set of the gripper device 21 and the effective surface 22. Each of the first impression cylinder 13, the second impression cylinder 14, the third impression cylinder 15, the drying cylinder 17 and fourth impression cylinder 18 includes two sets of the gripper devices 21 and the effective surfaces 22 and is a so-called double-size cylinder.

As shown in FIG. 2, the skeleton cylinder 16 is formed into a flat columnar shape in which two sets of gripper devices 21 are provided at two end portions. A space S is formed inside a rotation locus 16a of the skeleton cylinder 16 in order to prevent contact between the sheet 4 held by the gripper device 21 and the skeleton cylinder 16.

The delivery unit 3 of the double-sided varnishing apparatus 1 includes delivery chains 23 for conveying the sheet 4, and first to third delivery piles 24 to 26 to which the sheets 4 are discharged. The delivery chains 23 are wound around a pair of sprockets 27 and 28 and are driven to rotate by the sprockets 27 and 28. The delivery chains 23 are provided at positions spaced apart in the axial direction of the sprockets 27 and 28, respectively. Although not shown, a plurality of gripper bars are supported at a predetermined interval on the two delivery chains 23. These gripper bars are provided with grippers (not shown) each of which grips the gripping-side end portion of the sheet 4. Non-defective products are discharged to, of the first to third delivery piles 24 to 26, the first and second delivery piles 24 and 25 located on the upstream side in the sheet conveyance direction, and defective products are discharged to the third delivery pile 26. The quality determination will be explained later.

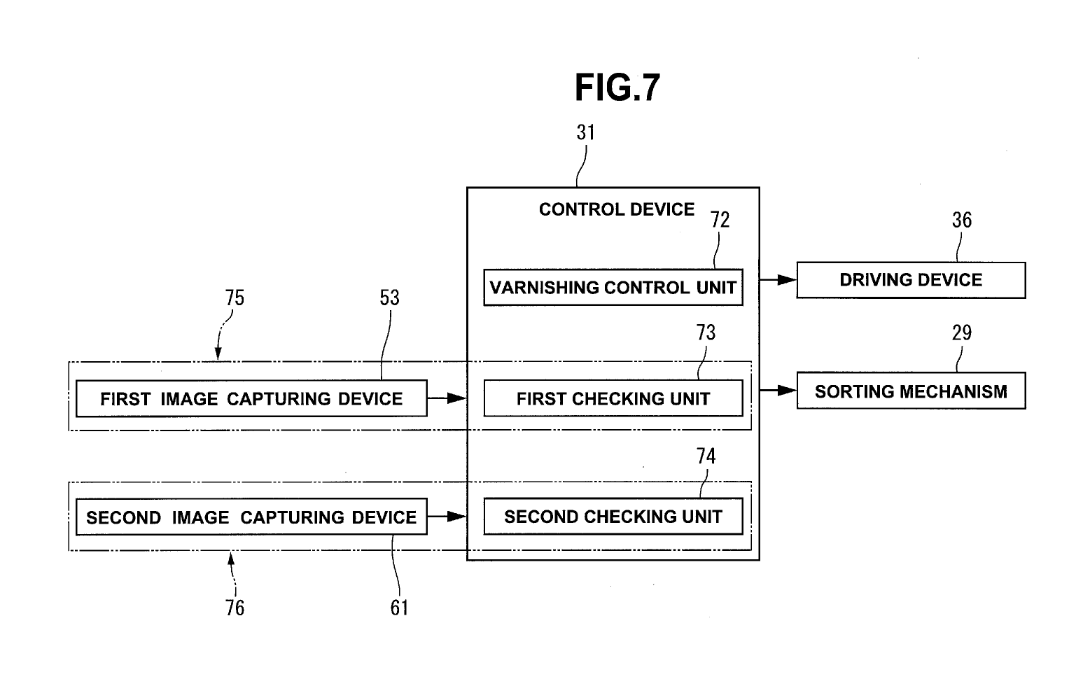

A sorting mechanism 29 is provided above the first to third delivery piles 24 to 26 to sort and discharge the sheets 4 to the first to third delivery piles 24 to 26. The sorting mechanism 29 switches the gripper from a state in which the sheet 4 is held by the gripper to a state in which the sheet 4 is released from the gripper. The operation of the sorting mechanism 29 is controlled by a control device 31 (FIG. 7) to be described later.

As shown in FIG. 1, the additional processing unit 5 is provided on the upstream side in the sheet conveyance direction with respect to the varnishing unit 6 to be described later. The additional processing unit 5 includes a special unit 32 that includes the first impression cylinder 13 and performs additional processing on the sheet 4, and a first embossing unit 33 that includes the second impression cylinder 14 and performs embossing on the sheet 4.

The special unit 32 is provided on the upstream side in the sheet conveyance direction with respect to the first embossing unit 33, and includes a frame 34A serving as the skeleton of the additional processing unit 5, the first impression cylinder 13, and a processing cylinder 35 facing the first impression cylinder 13. The frame 34A, the first impression cylinder 13, and the processing cylinder 35 constitute a main body 34 of the special unit 32.

The first impression cylinder 13 is rotatably supported by the frame 34A and is driven to rotate by a driving device 36 (see FIG. 7). In this embodiment, the first impression cylinder 13 corresponds to “impression cylinder that conveys a sheet”. The driving device 36 is a main apparatus motor that drives another cylinder of the double-sided varnishing apparatus 1 and rotating parts provided in the feeder unit 2 and the delivery unit 3. The operation of the driving device 36 is controlled by the control device 31 (see FIG. 7).

The processing cylinder 35 is configured by one corresponding to processing contents by the special unit 32. The special unit 32 according to this embodiment can perform one of three types of processes to be described later on one surface of the sheet 4. The three types of processes are offset printing, flexographic printing, and embossing.

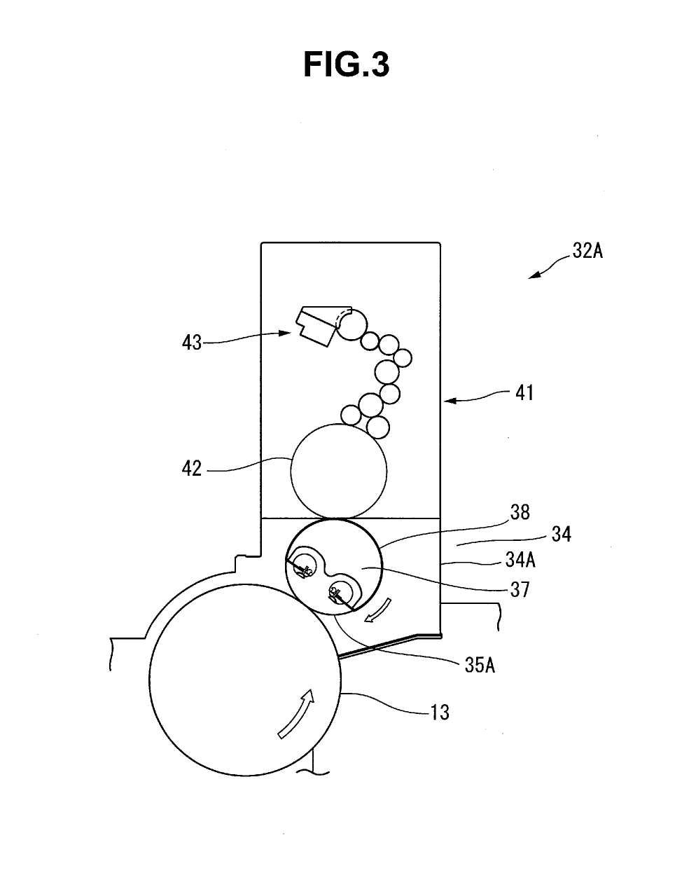

When the special unit 32 performs offset printing, the processing cylinder 35 is constituted by an offset printing blanket cylinder 35A and an offset printing module 41 is attached to the main body 34, as shown in FIG. 3. The special unit 32 in this case is an offset printing unit 32A that performs offset printing on the sheet 4. Although not shown in detail, the blanket cylinder 35A includes a cylinder main body 37 attached to the frame 34A of the main body 34 detachably and rotatably, and a blanket 38 wound around the outer peripheral surface of the cylinder main body 37. The offset printing module 41 includes a plate cylinder 42 that contacts the blanket cylinder 35A, and an inking device 43 configured to supply ink to the plate cylinder 42. The offset printing module 41 is detachable from the main body 34.

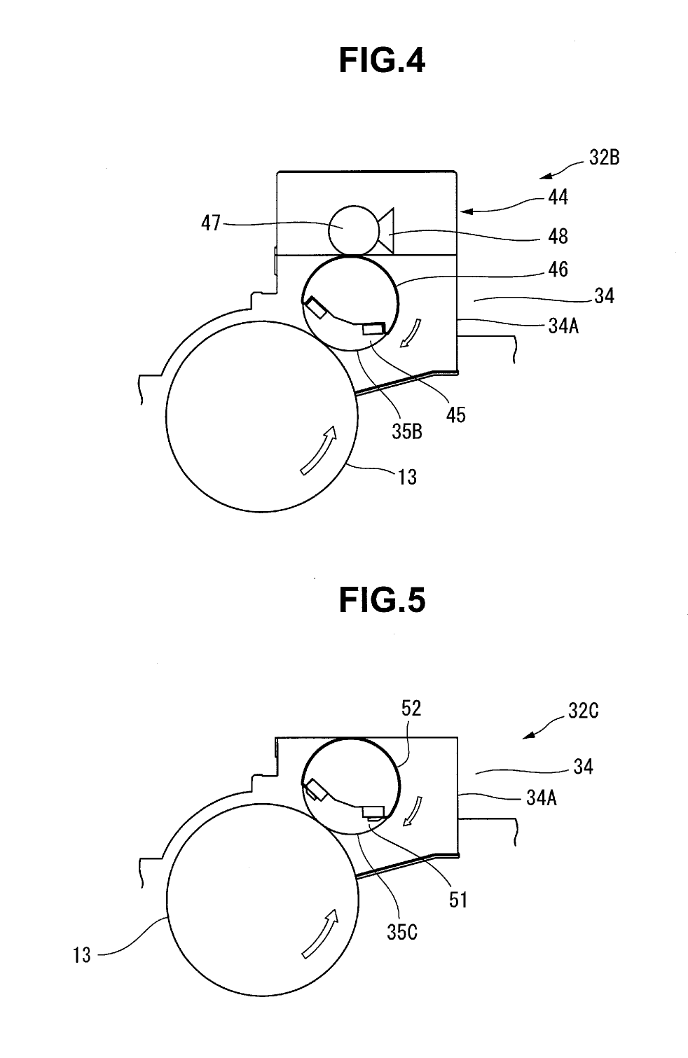

When the special unit 32 performs flexographic printing, the processing cylinder 35 is constituted by a flexographic plate cylinder 35B and a flexographic printing module 44 is attached to the main body 34, as shown in FIG. 4. The special unit 32 in this case is a flexographic printing unit 32B that performs flexographic printing on the sheet 4. The flexographic plate cylinder 35B includes a cylinder main body 45 attached to the frame 34A of the main body 34 detachably and rotatably, and a flexographic printing plate 46 wound around the outer peripheral surface of the cylinder main body 45. The flexographic printing module 44 includes an anilox roller 47 that contacts the flexographic plate cylinder 35B, and a chamber device 48 configured to supply ink to the anilox roller 47. The flexographic printing module 44 is detachable from the main body 34.

When the special unit 32 performs embossing, the processing cylinder 35 is constituted by an embossing cylinder 35C, as shown in FIG. 5. The special unit 32 in this case is a second embossing unit 32C that performs embossing on the sheet 4. The embossing cylinder 35C includes a cylinder main body 51 attached to the frame 34A of the main body 34 detachably and rotatably, and an embossing plate 52 wound around the outer peripheral surface of the cylinder main body 51. Although not shown, the plate 52 has a projection that is pressed against one surface of the sheet 4 to plastically deform the sheet 4 and form a convex portion on the other surface of the sheet 4. The convex portion formed on the sheet 4 by the second embossing unit 32C can be, for example, a fiducial mark that allows even a sight-impaired person to recognize it by touch.

In this way, the special unit 32 according to this embodiment is one of the offset printing unit 32A, the flexographic printing unit 32B, and the second embossing unit 32C. The offset printing unit 32A, the flexographic printing unit 32B, and the second embossing unit 32C are interchangeable with each other.

Ink used in the offset printing module 41 and the flexographic printing module 44 is ultraviolet curing ink. The ink transferred or applied to the sheet 4 by the modules 41 and 44 is cured by a first drying device 53 (see FIG. 1) while the sheet 4 is conveyed by the first impression cylinder 13.

The first drying device 53 is disposed to face the peripheral surface of the first impression cylinder 13 and emits ultraviolet rays toward the first impression cylinder 13. Note that when, for example, ink of a type that solidifies upon evaporation of a solvent is used in the offset printing module 41 and the flexographic printing module 44, a drying device that dries ink by emitting, for example, infrared rays to the sheet 4 is used as the first drying device 53. The first drying device 53 is a device that cures or dries ink, in other words, solidifies ink.

A first image capturing device 54 is arranged above the first drying device 53. The first image capturing device 54 is disposed to face the peripheral surface of the first impression cylinder 13. The first image capturing device 54 captures one surface of the sheet 4 conveyed by the first impression cylinder 13 and sends it as image data to the control device 31 to be described later. The image data obtained by the first image capturing device 54 includes an image printed on the sheet 4 before loading into the feeder unit 2, and a result of printing or coating by the offset printing module 41 or the flexographic printing module 44. An image capturing portion by the first image capturing device 54 is on the downstream side in the sheet conveyance direction with respect to the processing cylinder 35 and on the upstream side in the sheet conveyance direction with respect to a drying or curing portion by the first drying device 53.

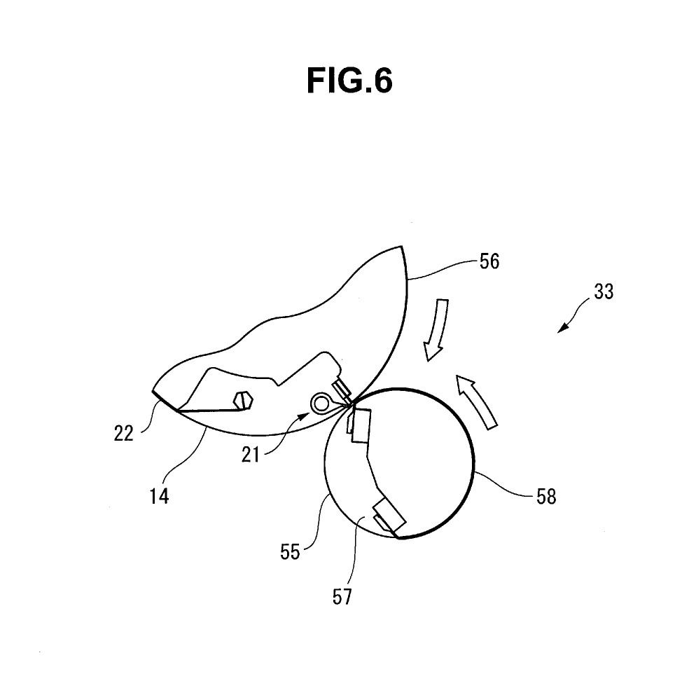

As shown in FIG. 6, the first embossing unit 33 provided on the downstream side in the sheet conveyance direction with respect to the special unit 32 includes the second impression cylinder 14 and an embossing cylinder 55 that contacts the second impression cylinder 14. The second impression cylinder 14 is rotatably supported by the main body 34. A blanket 56 is wound around the effective surface 22 of the second impression cylinder 14. The embossing cylinder 55 includes a cylinder main body 57 rotatably attached to the frame 34A of the main body 34, and an embossing plate 58 wound around the outer peripheral surface of the cylinder main body 57. Although not shown, the plate 58 has a projection that is pressed against the other surface of the sheet 4 to plastically deform the sheet 4 and form a convex portion on one surface of the sheet 4. The convex portion formed on the sheet 4 by the first embossing unit 33 can be, for example, a fiducial mark that allows even a sight-impaired person to recognize it by touch.

The embossing cylinder 55 is movably supported between a position where it contacts the second impression cylinder 14 and a position where it is spaced apart from the second impression cylinder 14. When the special unit 32 performs embossing, the embossing cylinder 55 can be moved apart from the second impression cylinder 14. When the special unit 32 performs offset printing or flexographic printing, the first embossing unit 33 can perform embossing on the sheet 4 by bringing the embossing cylinder 55 into contact with the second impression cylinder 14. That is, embossing can be performed in addition to offset or flexographic printing by the special unit 32 and double-sided varnishing, and high value can be added to the sheet 4.

The sheet 4 fed to the downstream side in the sheet conveyance direction with respect to the embossing cylinder 55 is captured by a second image capturing device 61 while the sheet 4 is conveyed by the second impression cylinder 14. The second image capturing device 61 is located below the third impression cylinder 15 and disposed to face the peripheral surface of the second impression cylinder 14. The second image capturing device 61 captures the other surface of the sheet 4 conveyed by the second impression cylinder 14 and sends it as image data to the control device 31 to be described later. The image data obtained by the second image capturing device 61 includes an image printed before loading into the feeder unit 2, a result of printing or coating by the offset printing module 41 or the flexographic printing module 44, and a result of embossing by the first embossing unit 33.

The varnishing unit 6 includes a first varnishing unit 62 having the third impression cylinder 15 that contacts the above-described second impression cylinder 14, and a second varnishing unit 63 disposed on the downstream side in the sheet conveyance direction with respect to the first varnishing unit 62. The first varnishing unit 62 and the second varnishing unit 63 are connected via the skeleton cylinder 16 and the drying cylinder 17.

The first varnishing unit 62 includes the third impression cylinder 15, a first varnishing plate cylinder 64 that contacts the third impression cylinder 15, an anilox roller 65 that contacts the first varnishing plate cylinder 64, a chamber device 66 that supplies varnish to the anilox roller 65, and the like. The first varnishing unit 62 coats one surface of the sheet 4 with varnish, and fills with the varnish a concave portion of one surface of the sheet 4 formed by the second embossing unit 32C. The varnish filling the concave portion increases the strength of the embossed portion. This varnish is ultraviolet curing varnish.

The sheet 4 having undergone varnishing on one surface by the first varnishing unit 62 is transferred from the third impression cylinder 15 to the skeleton cylinder 16, and fed from the skeleton cylinder 16 to the drying cylinder 17 in a state in which nothing contacts one surface. The varnish applied to one surface is solidified by a second drying device 67 while the sheet 4 is conveyed by the drying cylinder 17. The second drying device 67 is disposed between the first varnishing unit 62 and the second varnishing unit 63 at a position where it faces the drying cylinder 17. The second drying device 67 emits ultraviolet rays toward the peripheral surface of the drying cylinder 17.

The second varnishing unit 63 includes the fourth impression cylinder 18 that receives the sheet 4 from the drying cylinder 17, a second varnishing plate cylinder 68 that contacts the fourth impression cylinder 18, an anilox roller 69 that contacts the second varnishing plate cylinder 68, a chamber device 70 that supplies varnish to the anilox roller 69, and the like. The second varnishing unit 63 coats the other surface of the sheet 4 with varnish, and fills with the varnish a concave portion of the other surface of the sheet 4 formed by the first embossing unit 33. The varnish filling the concave portion increases the strength of the embossed portion. This varnish is also ultraviolet curing varnish.

The sheet 4 having undergone varnishing on the other surface by the second varnishing unit 63 is transferred from the fourth impression cylinder 18 to the gripper of the delivery unit 3, and conveyed by the delivery chains 23. This conveyance is performed in a state in which nothing contacts the other surface of the sheet 4. The varnish applied to the other surface of the sheet 4 is cured by a third drying device 71 while the sheet 4 is conveyed by the delivery chains 23. The third drying device 71 is disposed on the downstream side in the sheet conveyance direction with respect to the second varnishing unit 63 and below a sheet conveyance path formed in the delivery unit 3. The third drying device 71 emits ultraviolet rays toward the sheet 4 above.

Note that when, for example, varnish of a type that solidifies upon evaporation of a solvent is used in the first and second varnishing units 62 and 63, drying devices that dry varnish by emitting infrared rays to the sheet 4 are used as the second and third drying devices 67 and 71. The second and third drying devices 67 and 71 are devices that cure or dry varnish, in other words, solidifies varnish.

The sheet 4 with the varnish solidified on the other surface changes to a state in which the other surface directs up when the delivery chains 23 pass over the sprocket 28 located on the downstream side in the conveyance direction in the delivery unit 3. The sheet 4 is then sorted and discharged to one of the first to third delivery piles 24 to 26 by the sorting mechanism 29 whose operation is controlled by the control device 31.

As shown in FIG. 7, the control device 31 includes a varnishing control unit 72 and first and second checking units 73 and 74. The varnishing control unit 72 controls the operations of various actuators necessary to perform printing and varnishing on the sheet 4 by the double-sided varnishing apparatus 1.

The first checking unit 73 constitutes a first checking device 75 in corporation with the first image capturing device 54, and performs quality determination of an image of one surface of the sheet 4 based on image data sent from the first image capturing device 54. The second checking unit 74 constitutes a second checking device 76 in cooperation with the second image capturing device 61, and performs quality determination of an image of the other surface of the sheet 4 based on image data sent from the second image capturing device 61. The quality determination performed by the first checking unit 73 and the second checking unit 74 targets only an image printed on the sheet 4 in a process before loading into the double-sided varnishing apparatus 1, or an overall image having undergone processing by the additional processing unit 5 in addition to printing in the pre-process.

The first checking unit 73 and the second checking unit 74 control the operation of the sorting mechanism 29 so as to discharge to the first or second delivery pile 24 or 25 only the sheet 4 for which the result of quality determination is determined to be good. The sheet 4 for which the result is determined to be bad is discharged to the third delivery pile 26.

In the thus configured double-sided varnishing apparatus 1, processing by the special unit 32 and embossing by the first embossing unit 33 are performed on the sheet 4 on the upstream side in the sheet conveyance direction with respect to the varnishing unit 6. Hence, the additional processing unit 5 adds value to the sheet 4. The special unit 32 can selectively perform one of offset printing, flexographic printing, and embossing, various requests to the sheet 4 can be met, and the degree of freedom is high in value addition. According to this embodiment, it is possible to provide a double-sided varnishing apparatus capable of obtaining a high value-added sheet.

When the special unit 32 performs flexographic printing, for example, invisible ink can be used. When printing with the invisible ink and varnishing by the varnishing unit 6 come together, a special visual effect is obtained and high value is added. Even when the special unit 32 performs offset printing, invisible ink can be used. The density of ink used in offset printing is different from that of varnish. Since the two types of coatings different in density are formed on one surface of the sheet 4, the vision and touch differ from those of the other surface and high value is added. The flexographic printing or offset printing can be performed by the special unit 32 in association with a convex portion provided on one surface of the sheet 4 by the first embossing unit 33.

In this embodiment, the first embossing unit 33 located on the downstream side in the sheet conveyance direction with respect to the special unit 32 includes the second impression cylinder 14 and the embossing cylinder 55. Substantially, the second impression cylinder 14 functions as a transfer cylinder configured to feed the sheet 4 from the additional processing unit 5 to the varnishing unit 6. According to this embodiment, it is possible to provide a compact double-sided varnishing apparatus because no dedicated cylinder need be added when installing the first embossing unit 33.

The special unit 32 according to this embodiment includes the main body 34 having the frame 34A, the first impression cylinder 13 that is rotatably supported by the frame 34A and conveys the sheet 4, and the processing cylinder 35 that is rotatably supported by the frame 34A and faces the first impression cylinder 13. The offset printing unit 32A includes the offset printing module 41 having the plate cylinder 42 and the inking device 43 and supported to be detachable from the main body 34. The flexographic printing unit 32B includes the flexographic printing module 44 having the anilox roller 47 and the chamber device 48 and supported to be detachable from the main body 34.

When the special unit 32 performs offset printing, the processing cylinder 35 is constituted by the blanket cylinder 35A and the offset printing module 41 is attached to the main body 34. When the special unit 32 performs flexographic printing, the processing cylinder 35 is constituted by the flexographic plate cylinder 35B and the flexographic printing module 44 is attached to the main body 34. When the special unit 32 performs embossing, the processing cylinder 35 is constituted by the embossing cylinder 35C. According to this embodiment, it is therefore possible to provide a double-sided varnishing apparatus capable of easily switching between offset printing, flexographic printing, and embossing.

The double-sided varnishing apparatus 1 according to this embodiment includes the first, second, and third drying devices 53, 67, and 71. The first drying device 53 is disposed to face the peripheral surface of the first impression cylinder 13 of the special unit 32 and solidifies ink applied to the sheet 4 by the offset printing unit 32A or the flexographic printing unit 32B. The second drying device 67 is provided between the first varnishing unit 62 and the second varnishing unit 63 and solidifies varnish applied by the first varnishing unit 62. The third drying device 71 is provided on the downstream side in the sheet conveyance direction with respect to the second varnishing unit 63 and solidifies varnish applied by the second varnishing unit 63. Hence, it is possible to provide a double-sided varnishing apparatus capable of obtaining a high-quality and higher value-added sheet because ink or varnish applied to the sheet 4 is solidified immediately after coating.

In this embodiment, the double-sided varnishing apparatus includes the feeder unit 2 that supplies the printed sheet 4 to the special unit 32, the first checking device 75, and the second checking device 76. The first checking device 75 includes the first image capturing device 54 facing the peripheral surface of the first impression cylinder 13 of the special unit 32 and checks an image of one surface of the printed sheet 4. The second checking device 76 includes the second image capturing device 61 facing the peripheral surface of the second impression cylinder 14 of the first embossing unit 33 located on the downstream side in the sheet conveyance direction with respect to the special unit 32 and checks an image of the other surface of the printed sheet 4. Since images of both surfaces of the printed sheet 4 fed from the sheet supply device can be checked, the sheets 4 can be sorted into non-defective products and defective products. It is possible to provide a double-sided varnishing apparatus capable of excluding defective products and obtaining only non-defective products.

### EXPLANATION OF THE REFERENCE NUMERALS AND SIGNS

1 . . . varnishing apparatus, 2 . . . feeder unit, 4 . . . sheet, 5 . . . additional processing unit, 6 . . . varnishing unit, 13 . . . first impression cylinder, 32 . . . special unit, 32A . . . offset printing unit, 32B . . . flexographic printing unit, 32C . . . second embossing unit, 33 . . . first embossing unit, 34 . . . main body, 34A . . . frame, 35 . . . processing cylinder, 35A . . . blanket cylinder, 35B . . . flexographic plate cylinder, 35C, 55 . . . embossing cylinder, 41 . . . offset printing module, 42 . . . plate cylinder, 43 . . . inking device, 44 . . . flexographic printing module, 45 . . . cylinder main body, 47 . . . anilox roller, 48 . . . chamber device, 53 . . . first drying device, 54 . . . first image capturing device, 61 . . . second image capturing device, 62 . . . first varnishing unit, 63 . . . second varnishing unit, 67 . . . second drying device, 71 . . . third drying device, 75 . . . first checking device, 76 . . . second checking device

1. A double-sided varnishing apparatus comprising:
a varnishing unit including a first varnishing unit configured to apply varnish to one surface of a sheet, and a second varnishing unit arranged on a downstream side in a sheet conveyance direction with respect to the first varnishing unit and configured to apply varnish to the other surface of the sheet; and
an additional processing unit provided on an upstream side in the sheet conveyance direction with respect to the varnishing unit and configured to perform additional processing on the sheet,
wherein the additional processing unit includes
a first embossing unit configured to perform embossing on the sheet, and
a special unit provided on the upstream side in the sheet conveyance direction with respect to the first embossing unit and configured to perform additional processing on the sheet,
the special unit is one of
an offset printing unit configured to perform offset printing on the sheet, a flexographic printing unit configured to perform flexographic printing on the sheet, and
a second embossing unit configured to perform embossing on the sheet, and
the offset printing unit, the flexographic printing unit, and the second embossing unit are configured to be interchangeable with each other.

2. The double-sided varnishing apparatus according to claim 1, wherein
the special unit includes a main body including a frame, a first impression cylinder rotatably supported by the frame and configured to convey the sheet, and a processing cylinder rotatably supported by the frame and facing the first impression cylinder,
the offset printing unit includes an offset printing module including a plate cylinder and an inking device and supported to be detachable from the main body,
the flexographic printing unit includes a flexographic printing module including an anilox roller and a chamber device and supported to be detachable from the main body,
when the special unit performs offset printing, the processing cylinder is constituted by a blanket cylinder and the offset printing module is attached to the main body,
when the special unit performs flexographic printing, the processing cylinder is constituted by a flexographic plate cylinder and the flexographic printing module is attached to the main body, and
when the special unit performs embossing, the processing cylinder is constituted by an embossing cylinder.

3. The double-sided varnishing apparatus according to claim 2, further comprising:
a first drying device disposed to face a peripheral surface of the first impression cylinder of the special unit and configured to solidify ink printed on the sheet by one of the offset printing unit and the flexographic printing unit;
a second drying device provided between the first varnishing unit and the second varnishing unit and configured to solidify varnish applied by the first varnishing unit; and
a third drying device provided on the downstream side in the sheet conveyance direction with respect to the second varnishing unit and configured to solidify varnish applied by the second varnishing unit.

4. The double-sided varnishing apparatus according to claim 2, further comprising:
a sheet supply device configured to supply a printed sheet to the special unit;
a first checking device including a first image capturing device disposed to face a peripheral surface of the first impression cylinder of the special unit and configured to check an image of one surface of the printed sheet captured by the first image capturing device; and
a second checking device including a second image capturing device disposed to face a peripheral surface of a second impression cylinder of the first embossing unit and configured to check an image of the other surface of the printed sheet captured by the second image capturing device.
